(19) United States
(12) Patent Application Publication
(10) Pub. No.: US 2025/0038587 A1
(43) Pub. Date: Jan. 30, 2025

(54) COIL FOR A STATOR OF AN ELECTRIC MOTOR, STATOR, AND MANUFACTURING METHOD

(71) Applicant: VALEO SYSTÈMES D'ESSUYAGE, Le Mesnil Saint Denis (FR)

(72) Inventors: Gilles Neron, Issoire (FR); Olivier Marroux, Chatellerault (FR); Alain Servin, Chatellerault (FR); Jose Luis Herrada, Le Mesnil Saint Denis (FR)

(73) Assignee: VALEO SYSTÈMES D'ESSUYAGE, Le Mesnil Saint Denis (FR)

(21) Appl. No.: 18/696,912

(22) PCT Filed: Sep. 30, 2022
(86) PCT No.: PCT/EP2022/077313

§ 371 Date: Mar. 28, 2024

(30) Foreign Application Priority Data
Sep. 30, 2021 (FR) FR2110370

(51) Int. Cl. H02K 1/16; H02K 3/12; H02K 5/22; H02K 7/00; H02K 15/04

(52) U.S. Cl. CPC H02K 1/16; H02K 3/12; H02K 5/225; H02K 7/003; H02K 15/0435

(57) ABSTRACT

A coil of a stator for an electric motor is disclosed. The coil includes a reel forming a tooth of the stator. The reel includes a tubular central shaft including multiple grooves formed on its periphery between a first end of the central shaft configured to be oriented towards the center of the stator and a second end of the central shaft configured to be oriented towards the outside of the stator. The grooves are configured to receive a turn of a winding wire wound around the reel. The reel also includes a first retaining collar located at the first end of the central shaft, a second retaining collar located on the second end of the central shaft, and a winding formed by the winding wire configured to be wound around the reel between the first retaining collar the second retaining collar.

The present invention relates to the field of electric motors, particularly electric motors intended to be fitted to electric bicycles.

Electric bicycles are becoming increasingly popular because of the ease of travel they provide while consuming less energy, having a lower environmental impact and costing less.

However, use in an electric bicycle involves a number of constraints. In particular, high torque and low rotational speed need to be provided so as to offer effective assistance while at the same time being compatible with the pedaling cadence of the cyclist.

Furthermore, positioning the electric motor on the bicycle, generally in the region of the bottom bracket of the bicycle, involves size constraints in order to allow the electric motor to be installed without compromising other features of the bicycle.

In order to address these constraints, it is therefore necessary to keep the space requirement of the electric motor and, in particular, of the stator coils, as small as possible. One way of limiting this space requirement is to use a winding referred to as a trapezoidal winding in which the two ends of the coil have different numbers of turn layers. However, a problem that can arise with such a winding relates to holding the last turn in position. Indeed, this last turn tends to slide towards the internal end of the coil because there is no adjacent turn or reel wall to hold the turn in position. However, if the last turn moves, this may lead to a short circuit with the turns of an adjacent coil, resulting in a malfunction or even damage to the electric motor. It is therefore necessary to find a solution that helps limit the space requirement of the coils of the stator while ensuring the correct operation of the electric motor.

The subject matter of the invention is therefore a coil of a stator for an electric motor comprising:
a reel forming a tooth of the stator comprising:
a tubular central shaft comprising a plurality of grooves formed on its periphery between a first end of the central shaft intended to be oriented towards the center of the stator and a second end of the central shaft intended to be oriented towards the outside of the stator, the grooves being intended to receive a turn of a winding wire wound around the reel,
a first retaining collar located on the first end of the central shaft,
a second retaining collar located on the second end of the central shaft,
a winding formed by the winding wire configured to be wound around the reel between the first and the second retaining collar,

wherein the coil comprises an internal portion intended to receive a first number of turn layers and an external portion intended to receive a second number of turn layers that is greater than the first number, in order to form a trapezoidal winding, and wherein a first end of the winding wire is positioned on the side of the first end of the central shaft of the reel, and the start of the winding of the winding wire is produced on a groove located at the interface between the internal portion and the external portion of the coil.

According to another aspect of the present invention, the coil also comprises a first connector configured to receive the first end of the winding wire and a second connector configured to receive a second end of the winding wire, said first and second connectors being arranged on the side of the first retaining collar.

According to an additional aspect of the present invention, the first connector and the second connector are made as one piece with the reel.

According to an additional aspect of the present invention, the reel comprises a raised portion situated in a region between the first collar and the interface between the internal portion and the external portion forming a guide ramp for the winding wire between the first connector and the groove located at the interface between the internal portion and the external portion of the coil.

According to another aspect of the present invention, the height of the raised portion is between 0.8 and 1.2 times the diameter of the winding wire.

According to an additional aspect of the present invention, the winding comprises two turn layers on the internal portion and three turn layers on the external portion.

According to an additional aspect of the present invention, the start of the winding of the winding wire is made towards the second end of the central shaft.

According to another aspect of the present invention, the grooves are inclined in relation to a plane normal to the shaft of the reel, the width and the inclination of the grooves being determined in such a way that turns of the winding arranged in two adjacent grooves are adjacent and the successive turns form a helical winding around the central shaft.

According to an additional aspect of the present invention, the central shaft of the reel has a rectangular cross section.

According to an additional aspect of the present invention, the coil forms a separate tooth of the stator that is configured to be positioned on a central module of the stator after producing the winding.

The present invention also relates to a stator for an electric motor comprising a plurality of coils as described above.
According to another aspect of the present invention, the coils are connected in a star or Delta configuration.

The present invention also relates to an electric motor comprising a stator as described above, wherein said electric motor is a three-phase brushless motor.

The present invention also relates to a method for manufacturing a coil of a stator for an electric motor comprising a reel on which a plurality of grooves is formed, arranged on the periphery of a central shaft of the reel between a first end of the central shaft intended to be oriented towards the inside of the stator and a second end of the central shaft intended to be oriented towards the outside of the stator, said grooves being distributed between an internal portion of the coil intended to receive a first number of turn layers and an external portion of the coil intended to receive a second number of turn layers greater than the first number in order to form a trapezoidal winding, said method comprising a step of winding a winding wire around the central shaft of the reel wherein the winding starts with a groove located at the interface between the internal portion and the external portion.

According to an additional aspect of the present invention, the step of winding the winding wire is completed at one end of the central shaft of the reel and a second end of the winding wire associated with the end of the winding is attached at a first end of the reel intended to be oriented towards the inside of the stator. Further features and advantages of the invention will become more clearly apparent from reading the following description, which is given by way of illustrative and non-limiting example, and the appended drawings, in which:

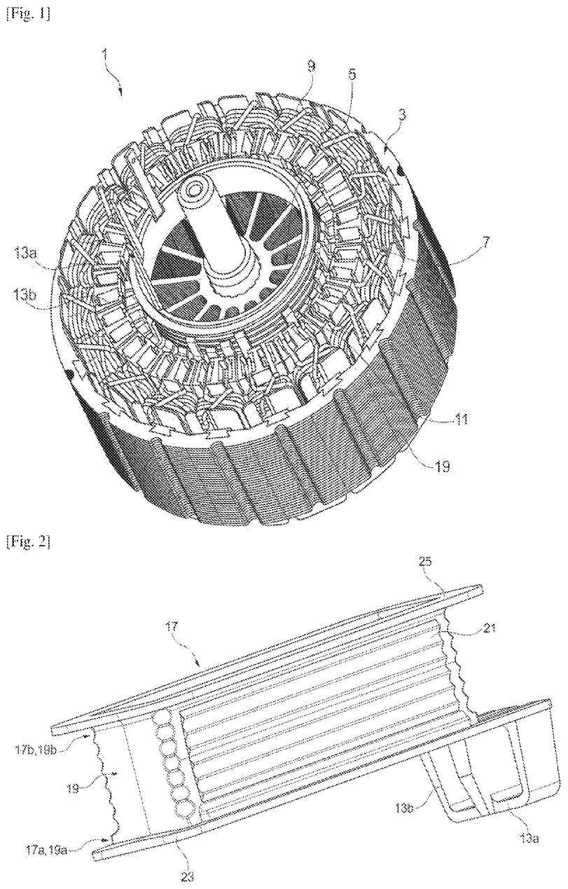

FIG. 1 shows a schematic perspective view of part of an electric motor;

FIG. 2 shows a first schematic perspective view of a reel of a coil of a stator;

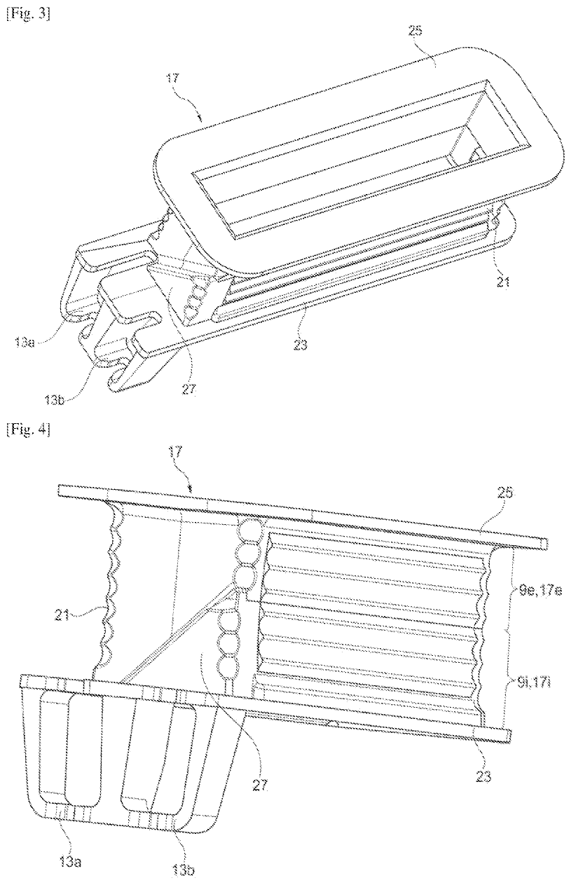

FIG. 3 shows a second schematic perspective view of a reel of a coil of a stator;

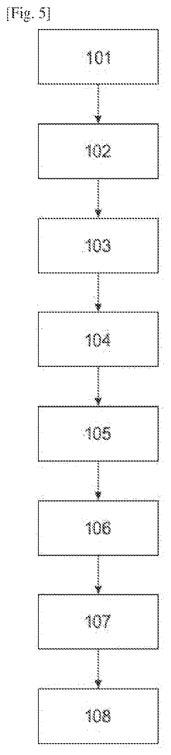

FIG. 4 shows a third schematic perspective view of a reel of a coil of a stator;

FIG. 5 shows a flowchart of the steps of a method for manufacturing a coil according to the present invention;

FIG. 6 shows a schematic cross-section view of a coil during a first winding step;

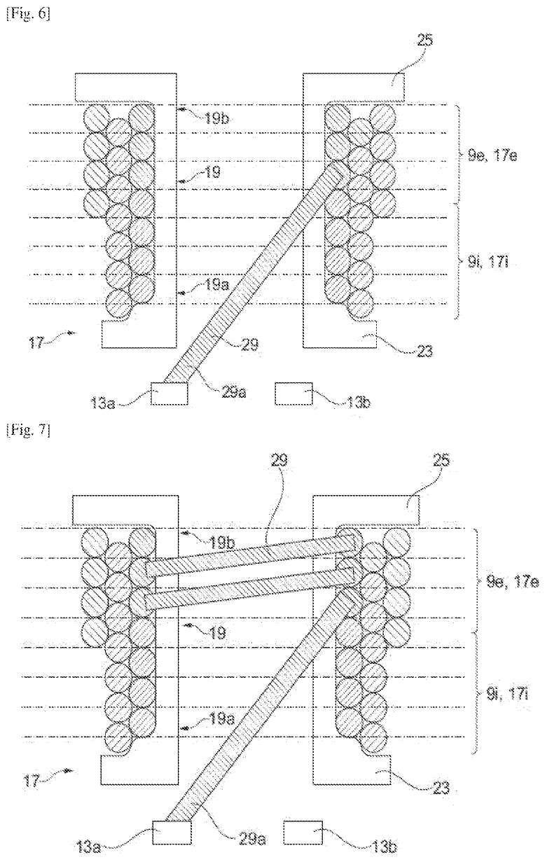

FIG. 7 shows a schematic cross-section view of a coil during a second winding step;

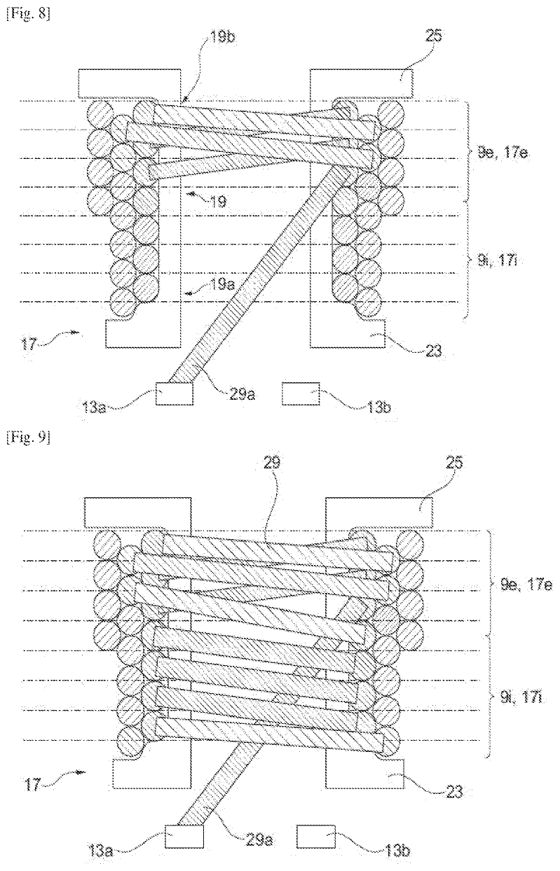

FIG. 8 shows a schematic cross-section view of a coil during a third winding step;

FIG. 9 shows a schematic cross-section view of a coil during a fourth winding step;

FIG. 10 shows a schematic cross-section view of a coil during a fifth winding step;

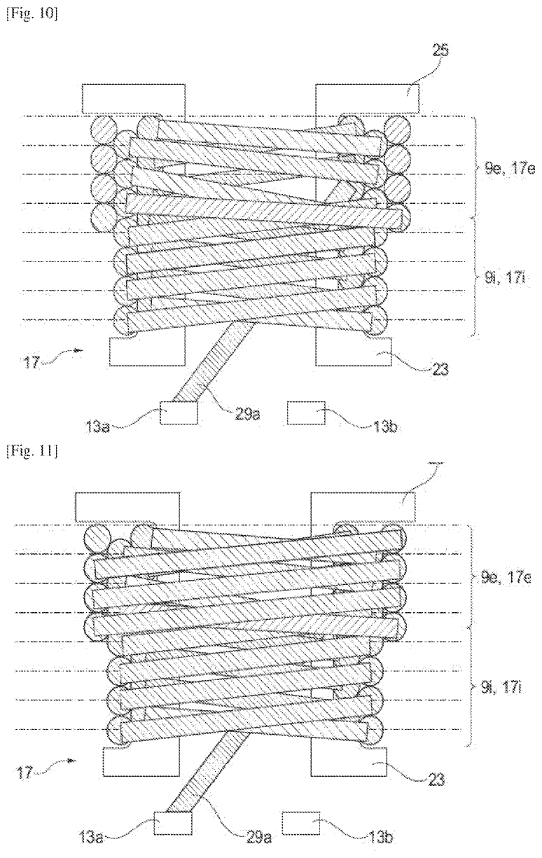

FIG. 11 shows a schematic cross-section view of a coil during a sixth winding step;

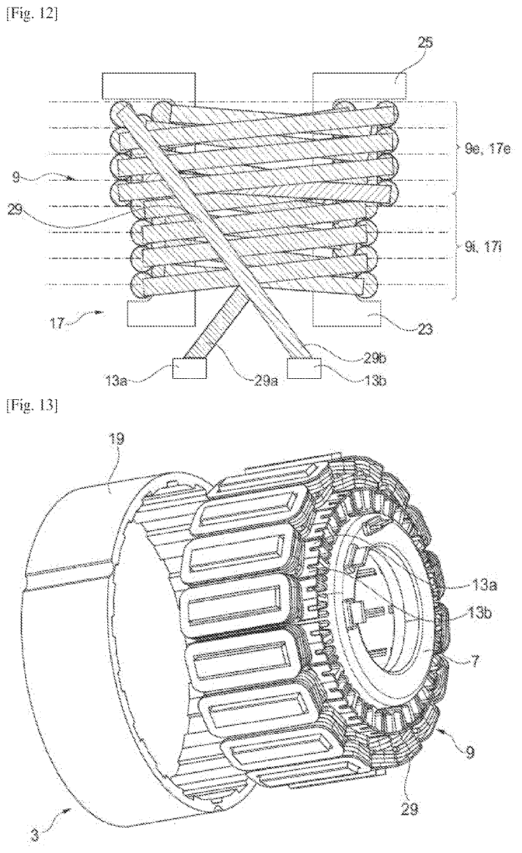

FIG. 12 shows a schematic cross-section view of a coil at the end of winding;

FIG. 13 shows a schematic perspective view of a stator with separate teeth;

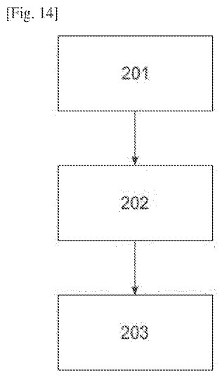

FIG. 14 shows a flowchart of the steps of a method for manufacturing a stator according to the present invention.

In these figures, identical elements have the same reference signs.

The following embodiments are examples. Although the description refers to one or more embodiments, this does not necessarily mean that each reference relates to the same embodiment, or that the features apply only to a single embodiment. Individual features of various embodiments may also be combined or interchanged to create other embodiments.

In the present description, certain elements or parameters may be indexed, for example first element or second element and also first parameter and second parameter or first criterion and second criterion, etc. In this case, this is simply indexing to differentiate and designate elements or parameters or criteria that are similar but not identical. This indexing does not imply priority being given to one element, parameter or criterion over another and such designation may be interchanged easily without departing from the scope of the present description. Neither does this indexing imply any chronological order for example in assessing any given criterion.

FIG. 1 is a diagram of part of an electric motor 1 comprising a stator 3 and a rotor 5. The electric motor 1 is a three-phase brushless electric motor, for example, although the present invention is not limited to this type of electric motor. Such an electric motor 1 is particularly suitable for being fitted to an electric bicycle, but the present invention is not limited to this application.

The stator 3 comprises a central module 7 and a plurality of teeth formed by coils 9 and arranged around the central module 7. The coils 9 form, for example, separate teeth configured to be fastened to the central module 7. The central module 7 comprises, for example, connection frames 11 configured to connect the different coils 9 according to a predefined electrical diagram, for example a star configuration. The connection frames 11 comprise, for example, connecting tabs extending radially. The coils 9 comprise, for example, connectors 13a and 13b configured to receive the ends 29a, 29b of the winding wires 29. The connectors match the connecting tabs and are configured to be positioned on the connecting tabs in order to provide an electrical connection between the ends of the winding wires 15 and the connection frames 11.

FIG. 2 shows a schematic perspective view of a reel 17 of a coil 9. The reel 17 forms the support onto which the winding wire 29 is wound in order to form the coil 9. The reel 17 comprises a tubular central shaft 19. In the present case, the cross section of the central shaft 19 is rectangular, but other cross-sectional shapes may also be used. The central shaft 19 comprises a plurality of grooves 21 arranged on its periphery and configured to receive turns of winding wire 29. The grooves 21 ensure that the turns of the first layer are held in position along the central shaft 19. The grooves 21 extend in a direction substantially perpendicular to the axial direction of the central shaft 19. However, the grooves 21 may be at an angle in relation to the direction perpendicular to the axial direction in order to allow the turns to be wound helically along the central shaft 19. The width of the grooves 21 is determined in such a way that two consecutive turns are adjacent. The grooves 21 are formed between a first end 19a of the central shaft 19 that also corresponds to a first end 17a of the reel 17 and a second end 19b of the central shaft 19 that also corresponds to a second end 17b of the reel 17. The first end 19a of the central shaft 19 is intended to be oriented towards the center of the stator 3 and comprises a first retaining collar 23 for retaining the winding wire 29. The second end 19b of the central shaft 19 is intended to be oriented towards the outside of the stator 3 and comprises a second retaining collar 25 for retaining the winding wire 29.

The reel 17 may also comprise a first connector 13a configured to receive a first end 29a of the winding wire 29 corresponding, for example, to the initial end of the winding wire 29, i.e., the end connected to a turn of the first layer (i.e., the layer in contact with the grooves 21 of the reel 17) and a second connector 13b configured to receive a second end 29b of the winding wire 29 corresponding, for example, to the final end of the winding wire 29, i.e., the end connected to a turn of the last layer (i.e., the peripheral layer).

In the present case, the first 13a and the second 13b connectors are situated on the internal side of the reel 17, i.e., the side of the reel 17 configured to be oriented towards the inside of the stator 3 when the stator 3 is assembled. The first 13a and second 13b connectors are, for example, fastened to the first retaining collar 23 and are made as one piece with the rest of the reel 17, for example.

According to one particular embodiment of the reel 17 shown in FIGS. 3 and 4, the reel 17 comprises a raised portion 27. The raised portion 27 is, for example, in the shape of a right-angled triangle, the hypotenuse of which forms a guide ramp for the winding wire 29 between the first connector 13a and a starting groove 21 for the winding. The height of the raised portion 27 is, for example, between 0.8 and 1.2 times the diameter of the winding wire 29.

The coil 9 also comprises a winding wire 29 (shown in FIGS. 6 to 12) configured to be wound around the reel 17 in order to form the winding. Moreover, the winding that is produced is a winding referred to as a trapezoidal winding, i.e., the number of turn layers is not the same over the entire axial length of the reel 17. Thus, the reel 17 and therefore the coil 9 comprise an internal portion 9i, 17i intended to receive a first number of turn layers, for example two layers, and an external portion 9e, 17e intended to receive a second number of turn layers greater than the first number, for example three layers. Moreover, since the first 13a and second 13b connectors intended to receive the ends 29a and 29b of the winding wire 29 are located at the first end 17a of the reel 17, i.e., the end intended to be oriented towards the center of the stator 3 when assembled, it is necessary to connect the first 29a and the second 29b ends of the winding wire 29 to this first end of the reel 17.

In order to obtain the desired winding, the winding of the winding wire 29 is started at a starting groove located at the interface between the internal portion 17i and the external portion 17e of the reel 17, for example at a central groove 21 of the reel if the internal 17i and external 17e portions are equal in size, but the starting groove may be on any groove 21 apart from the two end grooves. If the reel 17 comprises a raised portion 27 (as in FIGS. 3 and 4), the winding wire 29 may be guided from the first connector 13a to the starting groove along the raised portion 27. According to an alternative embodiment which is not shown, a slanting recess may be formed in the reel 17 in order to guide the winding wire 29 from the first connector 13a to the starting groove (to replace the raised portion 27).

The present invention also relates to a method for manufacturing a coil 9 as described above. FIG. 5 shows a flowchart of the steps of the manufacturing method.

The first step 101 relates to the positioning of the first end 29a of the winding wire 29 in the first connector 13a. The first connector 13a comprises, for example, one or more slots in which the first end 29a of the winding wire 29 is placed in order to be held in position.

The second step 102 relates to the positioning of the winding wire 29 between the first connector 13a and the starting groove, as shown in FIG. 6.

In the example of FIG. 6, the reel 17 comprises seven grooves 21, the dotted lines representing the separations between the different grooves 21, and the starting groove corresponds to the fifth groove (starting from the first end 19a of the central shaft 19). Moreover, the circles represent the position of the different turns at the end of the winding. If the reel 17 comprises a raised portion 27, the winding wire 29 extends along the raised portion 27 between the first connector 13a and the starting groove.

The third step 103 relates to the winding of the first layer of turns of the external portion 17e of the reel 17. The winding is produced from the starting groove, moving towards the external end 19b of the central shaft 19, following the adjacent grooves to produce the turns of the first layer of the external portion 9e of the coil 9, as shown in FIG. 7.

The fourth step 104 relates to the winding of the second layer of turns of the external portion 17e of the reel 17. When the winding reaches the groove 21 located at the second end 19b of the central shaft at the end of step 103, the winding starts the second layer of turns of the external portion 9e, moving towards the first end 19a of the central shaft 19, the winding being produced on top of the turns formed during step 103, as shown in FIG. 8. The turns of the second layer are positioned in the pseudo-groove formed at the interface between two adjacent turns of the first layer.

The fifth step 105 relates to the winding of the turns of the first layer of the internal portion 9i of the coil 9. When the winding reaches the internal portion 9i at the end of step 104, the turns are then wound in the grooves 21 of the internal portion 9i and are therefore turns of the first layer, as shown in FIG. 9.

The sixth step 106 relates to the winding of the turns of the second layer of the internal portion 9i of the coil 9. When the winding reaches the first end 19a at the end of step 105, the winding rises back towards the second end 19b to form the second layer of turns of the internal portion 9i of the coil 9, as shown in FIG. 10.

The seventh step 107 relates to the winding of the turns of the third layer of the external portion 9e of the coil 9. When the winding reaches the external portion 9e at the end of step 106, the turns form the third layer of this external portion 9e and the winding continues until it reaches the second end 19b, as shown in FIG. 11.

The eighth step 108 relates to the positioning of the second end 29b of the winding wire 29 in the second connector 13b, as shown in FIG. 12. At the end of the winding, at the end of step 107, the second end 29b of the winding wire 29 is attached to the second connector 13b, as shown in FIG. 11. This step 108 may comprise cutting the winding wire 29 to form the second end 29b of the winding wire 29. The second connector 13b comprises, for example, one or more slots in which the second end 29b of the winding wire 29 is placed in order to be held in position.

The last turn is held in position by the adjacent turn of the third layer.

It should be noted that the number of turns per layer and the number of layers may be different from the embodiment described above.

Thus, starting to wind the winding at a groove located at the interface between the internal portion 9i and the external portion 9e of the coil 9 makes it possible to obtain a trapezoidal winding whose ends are located on the short side of the trapezoid and whose last turn is held in position by the other turns and is therefore not in danger of sliding towards the short side of the trapezoid.

The present invention also relates to a stator 3 comprising a plurality of teeth formed by coils 9 like the coil 9 described above. The coils 9 form separate teeth configured to be positioned on a central module 7, as shown in FIG. 1. FIG. 13 shows an example of a stator 3 with separate teeth (the central module comprising the connection frames is not shown in FIG. 13). Therefore, after producing the coils 9 by winding the winding wire 29 onto the different reels, the coils 9 are positioned on the central module 7. The first 13a and second 13b connectors of the coils 9 are configured to come into contact with connection frames 11 configured to connect the ends 29a, 29b of the winding wires 29 of the coils 9 according to the desired electrical arrangement.

Using trapezoidal windings means that the coils 9 have a smaller space requirement than a stator 3 with standard windings and equivalent power. Moreover, starting the winding at a starting groove located between an internal portion 9i and an external portion 9e of a coil 9 that does not correspond to a groove at an end of the reel 17 ensures that the last turn of the winding is kept in position and thus prevents the last turn from sliding towards the center of the stator 3, which could lead to a short circuit with the winding wire 29 of an adjacent coil 9. The stator 3 also comprises a yoke 19 configured to be positioned around the coils 9.

The present invention also relates to a method for manufacturing a stator 3 as described hereinabove.

FIG. 14 shows a flowchart of the steps of the method for manufacturing such a stator 3.

The first step 201 relates to the production of the coils 9 as described above. The winding wire 29 is wound by a robot, for example, and the coils 9 may all be identical.

The second step 202 relates to the connection of the coils 9 forming separate teeth to the central module 7 so that the connecting tabs of the connection frames 11 are inserted into the first 13a and second 13b connectors in order to make the connection between the coils 9 and the connection frames 11. A connecting tab is configured to come into contact with an end 29a, 29b of the winding wire 29 at a first connector 13a or a second connector 13b. Fastening is achieved, for example, by clip-fastening the coils 9 onto the central module 7.

The third step 203 relates to the positioning of the yoke 19 around the coils 9 forming the separate teeth. The yoke 19 is positioned on the coils 9 by axial translation.

The present invention also relates to an electric motor 1 comprising a stator 3 as described above and a rotor 5 comprising a plurality of poles, for example 10 or 14 poles. The poles of the rotor 5 are formed by permanent magnets, for example, and are configured to interact with the coils of the stator 3 in order to cause the rotor 5 to be set in rotation.

Therefore, using a stator 3 with separate teeth configured to be fastened to a central module 7 comprising the connection frames providing the electrical connections between the coils 9 via connectors 13a, 13b provided on the reel 17 and a trapezoidal winding makes it possible to obtain a stator 3 and, therefore, an electric motor 1 with a reduced space requirement that can thus easily be incorporated into an electric bicycle, in particular. Moreover, such a configuration allows a simple and quick method for manufacturing the electric motor 1.

1. A coil of a stator for an electric motor the coil comprising:
a reel forming a tooth of the stator, comprising:
a tubular central shaft comprising a plurality of grooves formed on its periphery between a first end of the central shaft configured to be oriented towards the center of the stator and a second end of the central shaft intended configured to be oriented towards the outside of the stator,
wherein the grooves are configured to receive a turn of a winding wire wound around the reel,
a first retaining collar located on the first end of the central shaft,
a second retaining collar located on the second end of the central shaft, and
a winding formed by the winding wire configured to be wound around the reel between the first retaining collar and the second retaining collar,
wherein the coil comprises an internal portion configured to receive a first number of turn layers and an external portion configured to receive a second number of turn layers greater than the first number in order to form a trapezoidal winding,
wherein a first end of the winding wire is positioned on the side of the first end of the central shaft of the reel, and
wherein the start of the winding of the winding wire is produced on a groove located at the interface between the internal portion and the external portion of the coil.

2. The coil as claimed in claim 1,
also comprising a first connector configured to receive the first end of the winding wire and a second connector configured to receive a second end of the winding wire,
wherein the first and second connectors are arranged on the side of the first retaining collar.

3. The coil as claimed in claim 2,
wherein the first connector and the second connector are made as one piece with the reel.

4. The coil as claimed in claim 1,
wherein the reel comprises a raised portion situated in a region between the first collar and the interface between the internal portion and the external portion forming a guide ramp for the winding wire between the first connector and the groove located at the interface between the internal portion and the external portion of the coil.

5. The coil as claimed in claim 4,
wherein the height of the raised portion is between 0.8 and 1.2 times the diameter of the winding wire.

6. The coil as claimed in claim 1,
wherein the winding comprises two turn layers on the internal portion and three turn layers on the external portion.

7. The coil as claimed in claim 6,
wherein the start of the winding of the winding wire is made towards the second end of the central shaft.

8. The coil as claimed in claim 1,
wherein the grooves are inclined in relation to a plane normal to the shaft of the reel,
wherein the width and the inclination of the grooves is determined in such a way that turns of the winding arranged in two adjacent grooves are adjacent and the successive turns form a helical winding around the central shaft.

9. The coil as claimed in claim 1,
wherein the central shaft of the reel has a rectangular cross section.

10. The coil as claimed in claim 1,
wherein the coil forms a separate tooth of the stator configured to be positioned on a central module of the stator after producing the winding.

11. A stator for an electric motor comprising a plurality of coils as claimed in claim 1.

12. The stator as claimed in claim 11,
wherein the coils are connected in a star or Delta configuration.

13. An electric motor comprising a stator as claimed in claim 11,
wherein the electric motor is a three-phase brushless motor.

14. A method for manufacturing a coil of a stator for an electric motor,
the coil comprising a reel on which a plurality of grooves is formed, arranged on the periphery of a central shaft of the reel between a first end of the central shaft configured to be oriented towards the inside of the stator and a second end of the central shaft configured to be oriented towards the outside of the stator,
wherein the grooves are distributed between an internal portion of the coil configured to receive a first number of turn layers and an external portion of the coil configured to receive a second number of turn layers greater than the first number in order to form a trapezoidal winding, the method comprising:
winding a winding wire around the central shaft of the reel in which the winding starts with a groove located at the interface between the internal portion and the external portion.

15. A method for manufacturing a coil as claimed in claim 14,
wherein the winding the winding wire is completed at one end of the central shaft of the reel, and
wherein a second end of the winding wire associated with the end of the winding is attached at a first end of the reel configured to be oriented towards the inside of the stator.
